(19) United States
(12) Patent Application Publication
(10) Pub. No.: US 2003/0082258 A1
(43) Pub. Date: May 1, 2003

(54) Apparatus for molding brick and brick paver

(76) Inventor: James M. Henderson, Dalton, GA (US)

Correspondence Address: Micheline Kelly Johnson, Baker, Donelson, Bearman & Caldwell, 1800 Republic Centre, 633 Chestnut Street, Chattanooga, TN, 37450-1800, US

(21) Appl. No.: 09/982,170

(22) Filed: Oct. 18, 2001

(51) Int. Cl. B28B 3/08

(52) U.S. Cl. 425/354; 425/352; 425/436 R

(57) ABSTRACT

Continuous molding apparatus includes a raw material supplying portion, a mixing portion, a molding portion, a supporting portion, and ram portions for moving mixture through the apparatus. The molding portion is formed by portions of the supporting frame and mold faces of the ram portions, which act in concert to load, compress, transport, and deliver the molded product. Charge volume is determined by the controlled distance between front and rear ram portions when in position under the raw material supplying portion. The molded material receives the compression force along the positive and negative directions of the horizontal axis on its wear faces. The ability to use the apparatus on a continuous basis allows unlimited production runs and permits the apparatus to be self-cleaning.

### TECHNICAL FIELD

The present invention relates to a molding device for solid building elements such as architectural face brick and brick pavers, and more particularly to a machine which makes such solid building elements continuously and with molding compression along one axis, in both positive and negative directions thereof.

### BACKGROUND OF THE INVENTION

A traditional concrete block machine, used for producing cement-based brick, may be fitted with a set of brick or brick paver molds. These machines are fed from a batch mix of individually weighed components. Both mixer and machine must be shut down and cleaned when a color change or product change is made.

Alternatively, bricks may be produced by units designed for clay brick molding. Here, molding is achieved by extruding wet clay and subsequently cutting the wet clay to size with a wire or knife. Some specialty brick are made in mold trays by pressing wet clay into mold pockets, allowing them to dry, and then subsequently firing the bricks.

Many brick-making machines that are capable of producing cement-based bricks utilize vertical molding pressure. Some such machines also incorporate vibration of the mold to facilitate formation of the brick. Certain of these machines utilize indexing rotary tables with multiple molds that receive or perform a different process step at each index. Examples of the above-referenced machines are described in Benjey, U.S. Pat. No. 3,127,657; Prince, U.S. Pat. No. 3,904,723; Toncelli, U.S. Pat. No. 4,698,010; Whissell, U.S. Pat. No. 4,802,836, and others.

These machines may have twelve or more brick pockets measuring 16″ by 3⅝″ by 2¼″ arranged vertically and resting on a steel plate. Mix is dropped into the mold pockets. A mating mold top with mating pocket protrusions or rams is fitted automatically and the entire mold is vibrated and pressured from the mold top only. Such pressure may be described as downward pressure in the “y” axis, or “−y” pressure. The −y pressure continues until the top of the mix is compressed to approximately 7⅝″ from the steel plate. The mold sides are then lifted, sliding upward along the top mold protrusions, and lifted clean of the brick standing on end on the steel plate. The steel plate holding the brick is then moved to a rack for subsequent steam curing. Most such machines also utilize indexing rotary tables with multiple molds that receive or perform a different process step at each index.

Horizontally pressured cement-based brick molding machines are described in the art, but are not commonly in use. In Hereford, U.S. Pat. No. 5,145,692, a machine with two rotating tables having three mold boxes utilizing one compression cylinder and one ram press plate is described. Another machine, described in Davis, U.S. Pat. No. 4,836,762, utilizes a horizontal turntable to handle primary and removable lined secondary molds that may be horizontally compressed and exchanged for new empty secondary molds as required. A mobile machine described in Gross, U.S. Pat. No. 4,569,649, utilizes one horizontal cylinder to actuate two connected rams that operate on opposite sides of the machine. The machine has a pair of block forming molds at each end of the machine so that one brick is being formed while the other mold cavity is charging. The Gross machine also incorporates cylinder-actuated lift ram press faces in order to facilitate ejection of the brick by the compression ram.

Accordingly, the prior art machines, regardless of whether they employ vertical or horizontal pressing, have at least two and generally three or more active axes, both rotary and linear. The complexity of these devices constitutes a drawback, the results of which are fully evident.

Moreover, all of the prior art cement-based machines require the steam curing of brick and paver product subsequent to molding. This curing is required because a mix already hydrated to a level sufficient for self-curing would stick to and clog the machines of the prior art. This additional step not only adds to the complexity of the machine required, but it also adds to the completion time required for production.

### SUMMARY OF THE INVENTION

The present invention provides a machine for making face bricks and brick pavers which overcomes the disadvantages of the prior art and provides the desired qualities of a brick-making machine in producing brick in a continuous manner. The machine of the present invention avoids the delay associated with the discrete batch processing of the prior art. Moreover, the continuous production afforded by the present mold unit invention has the advantage of permitting unlimited production runs enabled by concurrently weighed and fed components. In addition, the machine of the present invention is self-cleaning and permits change of color additives without halting the machine.

The design of the present invention is highly efficient. The charging chamber, fed from the feed chute, serves as a measuring and shaping device prior to the compression function. The controlled distance between front and rear ram faces, when in position under the feed chute, determines the charge volume. Moreover, the solid top of the rear ram of the present invention functions as a shutoff valve at the bottom of the feed chute. Additionally, the present invention is designed so that it may be operated in parallel with additional machines of the present invention to enhance efficiency. Accordingly, if production of one machine must be stopped for any reason, production of the other machines can proceed independently with a minimum adverse affect on brick production.

The design of the machine of the present invention facilitates production of bricks having homogeneous density throughout. This is accomplished by compressing the brick material along one axis in the mold chamber, in both the positive and negative directions of the axis. Moreover, it is the exposed brick or paver wear faces that receive the compression force. This results in making the faces more dense, while maintaining sufficient load bearing capacity in the perpendicular axis of the brick or paver.

The design of the present invention overcomes the disadvantage of the prior art whereby a mix hydrated to a level sufficient for self-curing would stick to and clog the machines of the prior art. This is accomplished by additional, continuous mixing in the charge chamber (after delivery of the mix from a main auger-type mixer) and by the self-cleaning action of the ram design.

The present invention is a simpler mechanical device than those of the prior art. All phases of the molding are performed in one axis with two independently controlled rams. A second axis, though not part of the actual molding mechanism, is the indexing plate on a perpendicular axis, which accepts delivery of the ejected brick. The rams act in concert to perform multiple functions: loading, compressing, transporting, and delivering the brick or paver.

These and other advantages are accomplished by the present invention of a machine for making brick and brick paver. The machine provides a pair of reciprocal ram heads, each driven by a separate dual-action hydraulic cylinder having an internal piston, and a charge chamber fed by a feed chute. The front and rear rams move in concert along the flat bottom of the charge chamber. The movement of the rams causes the measurement of the correct amount of charge and its positioning into the mold chamber. At the same time, the solid flat upper surface of the rear ram seals off the additional charge in the feed chute. The front ram stops its motion at the right side of the mold chamber and reverses while the rear ram continues its advance into the mold chamber until the ram faces are an appropriate distance apart. This motion compresses the charge into an appropriately sized brick or paver. The front ram then retracts from the mold chamber, across the indexing plate to its home position. The rear ram pushes the brick onto the indexing plate and immediately retracts into the mold chamber and pauses while the indexing plate indexes and is ready to receive another brick. The rear ram continues retracting to its starting position. Additional crumb charge falls into the charge chamber as the rear ram retracts and the cycle begins again.

### BRIEF DESCRIPTION OF THE DRAWINGS

FIG. 1 is a top plan view of the machine of the present invention;

FIG. 2 is a side elevational view of the machine of the present invention;

FIG. 3 is a top plan view of the machine of the present invention showing the front and rear rams moving the crumb charge into the mold chamber;

FIG. 4 is a side elevational view of the machine of the present invention at the same stage of production as shown in FIG. 3;

FIG. 5 is a top plan view of the machine of the present invention at the compression position;

FIG. 6 is a side elevational view of the machine at the compression position;

FIG. 7 is a top plan view of the machine after it has deposited a freshly made brick onto the indexing plate; and

FIG. 8 is a side elevational view of the machine of the present invention at the same stage as shown in FIG. 7.

### DETAILED DESCRIPTION OF THE PREFERRED EMBODIMENT

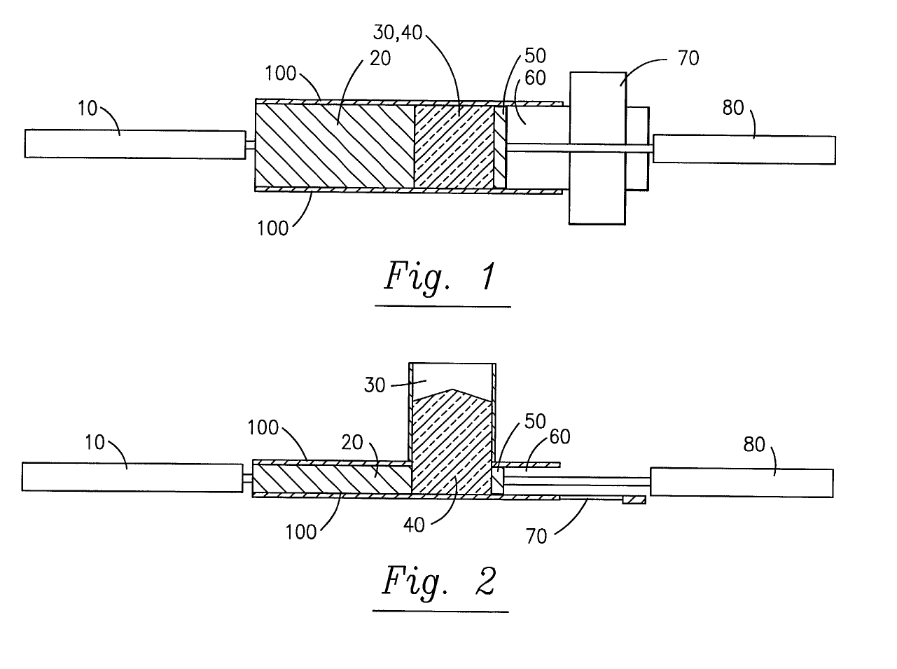

Referring more particularly to the drawings and initially to FIGS. 1 and 2, there is shown the machine of the present invention. The machine or mold unit includes a frame 100, onto which is mounted a rear ram 20 for longitudinal movement. A dual-action hydraulic rear cylinder 10 having an internal piston or other means for movement is provided. The rear cylinder 10 and the piston are attached to the rear ram 20 and the support frame 100 to move the rear ram longitudinally with respect to the support frame 100.

Still referring to FIGS. 1 and 2, mounted on the frame 100 is a feed chute 30 into which clay or cementious material may be placed. The portion of the frame 100 directly below the feed chute 30 forms the bottom of charge chamber 40. The mold face of the rear ram 20 is positioned at the left side of the charge chamber 40, and in fact forms the left side thereof when positioned appropriately. On the frame 100 opposite the rear ram 20 are the front ram 50 and dual-action hydraulic front cylinder 80 having an internal piston, mounted for longitudinal movement. The front cylinder 80 and the piston are attached to the front ram 50 in the support frame 100 to move the front ram 50 longitudinally with respect to the support frame 100.

As may best be seen in FIG. 1, the indexing plate 70 is positioned perpendicularly, between the front 50 and rear 20 ram faces, to one or multiple parallel mold units spaced appropriately so that the indexing plate 70 receives 1 brick from each mold unit on each cycle, and then indexes and receives the next cycle of bricks. If the parallel mold units are spaced 30 inches apart on center, a 10 inch index between cycles results in 2 inch spacing between the paver and 2⅜ inch spacing between brick ends. Three cycles fill one indexing plate 70. The plate 70 is then fed into a receiving rack (not shown) and a new empty plate 70 is positioned to receive the next cycle of bricks.

It will be appreciated that the indexing plate 70 seen in FIG. 1 moves in a gap between the front 50 and rear 20 ram faces and is supported by a device such as rollers located at each gap. The plate index 70 may be driven by any number of means, including an intermittently energized electromagnet attached to a hydraulic cylinder located parallel to and above the plate 70 magazine. In this case, when an index is required, the cylinder begins from the retracted position with the electromagnet attached to the rod end and working pole face resting on the top surface of the plate 70 being fed. The electromagnet is energized to grip the plate 70 and the cylinder extends a distance, preferably 10 inches. The electromagnet is then de-energized and the cylinder retracts to its original position, ready for the next index.

The machine of the present invention does not include an apparatus to provide steam curing after production of brick or brick paver. The ram design and continuous mixing of the present invention facilitates use of a crumb charge, or cement mix, with a moisture content sufficient for self-curing following molding. Testing indicates that bricks and brick pavers produced by the machine of the present invention exceed relevant strength and absorption requirements.

### EXAMPLE 1

Cement, water, and a fine aggregate were mixed and molded in the machine of the present invention:

TABLE 1

| | | Load | Total | Compressive | |
|---|---|---|---|---|---|
| Sample | Dimensions | Area | Load | Strength | |
| Number | L × W (in) | (in²) | (lbs.) | (psi) | Absorption % |
| 5/30-5 | 3.6 × 3.5 | 12.60 | 62,500 | 4,960 | 8.3 |

The sample of Example 1 exceeds requirements of the American Society for Testing and Materials (ASTM C 55-99, standard specifications of concrete brick) (namely, 3000 psi and 12.4%, discussed below).

### EXAMPLE 2

Cement, water, and a fine aggregate were mixed and molded in the machine of the present invention:

TABLE 2

| | | Load | Total | Compressive | |
|---|---|---|---|---|---|
| Sample | Dimensions | Area | Load | Strength | |
| Number | L × W (in) | (in²) | (lbs.) | (psi) | Absorption % |
| 5/30-1 | 3.55 × 3.6 | 12.78 | 55,000 | 4,304 | 9.0 |

The sample of Example 2 exceeds requirements of the American Society for Testing and Materials (ASTM C 55-99, standard specifications of concrete brick).

### EXAMPLE 3

Cement, water, and a fine aggregate were mixed and molded in the machine of the present invention:

TABLE 3

| | | Load | Total | Compressive | |
|---|---|---|---|---|---|
| Sample | Dimensions | Area | Load | Strength | |
| Number | L × W (in) | (in²) | (lbs.) | (psi) | Absorption % |
| 5/29-3 | 3.5 × 3.55 | 12.43 | 45,300 | 3,646 | 9.1 |

The sample of Example 3 exceeds requirements of the American Society for Testing and Materials (ASTM C 55-99, standard specifications of concrete brick).

### EXAMPLE 4

Cement, water, and a fine aggregate were mixed and molded in the machine of the present invention:

TABLE 4

| | | Load | Total | Compressive | |
|---|---|---|---|---|---|
| Sample | Dimensions | Area | Load | Strength | |
| Number | L × W (in) | (in²) | (lbs.) | (psi) | Absorption % |
| 5/29-2 | 3.6 × 3.6 | 12.96 | 46,000 | 3,549 | 9.4 |

The sample of Example 4 exceeds requirements of the American Society for Testing and Materials (ASTM C 55-99, standard specifications of concrete brick).

The average data of the above examples indicates compressive strength of 4,115 pounds per square inch (psi), and absorption of 8.95%. The ambient density of the examples averages 125.95 pounds per cubic foot (lb/cu. ft.). Given a moisture regain of approximately one to two percent, the samples fall into the medium weight classification under ASTM specification C 55-99 (125 lb/cu. ft. maximum) on an oven dry basis. This density requires a maximum absorption limit of 12.4% (13 lb/cu. ft.÷105 lb/cu. ft.). The compression requirement is 3,000 psi individual and 3,500 psi average of three. See ASTM Specification C 55-99, Table 2. Accordingly, as all the above examples demonstrate, the machine of the present invention produces, without subsequent steam curing, brick products that more than exceed standard requirements.

Moreover, the drying shrinkage of these examples is essentially zero (0.0004%). This far exceeds the moisture content requirement for type I grade N brick units (from 0.03 to 0.065% total linear drying shrinkage). See ASTM Specification C 55-99, Table 1. Units produced by the machine of the present invention have been measured at 0.917% moisture content at 44% relative humidity, 84° Fahrenheit, and a dew point of 57° Fahrenheit.

Referring again to FIG. 1 and FIG. 2, the functioning of the present invention begins with the feed chute 30 accepting the intermediate product crumb from a device such as a screw conveyor bin that is fed from a mixer. A stirrer or similar device inside the feed chute 30 distributes the crumb uniformly in the charge chamber 40. With the charge chamber 40 filled and the feed chute 30 partially filled, the molding cycle of the present invention proceeds.

As is best seen in FIG. 2, the mold face of the rear ram 20 is positioned at the left side of the charge chamber 40. The mold face of the front ram 50 is positioned at the right side of the charge chamber 40. In a preferred embodiment of the machine of the present invention, the dimensions of the charge chamber 40 for the production of face brick are preferably 7 inches between the mold face of the front ram 50 and the mold face of the rear ram 20, and 7⅝ inches between the sides of charge chamber 40. The bottom of charge chamber 40 is flat. As illustrated in FIG. 2, the bottom of charge chamber 40 is formed by a portion of the frame 100. The dimensions of the mold faces of rear ram 20 and front ram 50 are preferably 7⅝ inches by 2¼ inches, but may vary as desired. In a preferred embodiment of the present invention, therefore, the volume of the mold chamber 60 and the amount of crumb that proceeds to the next step is 120 cubic inches.

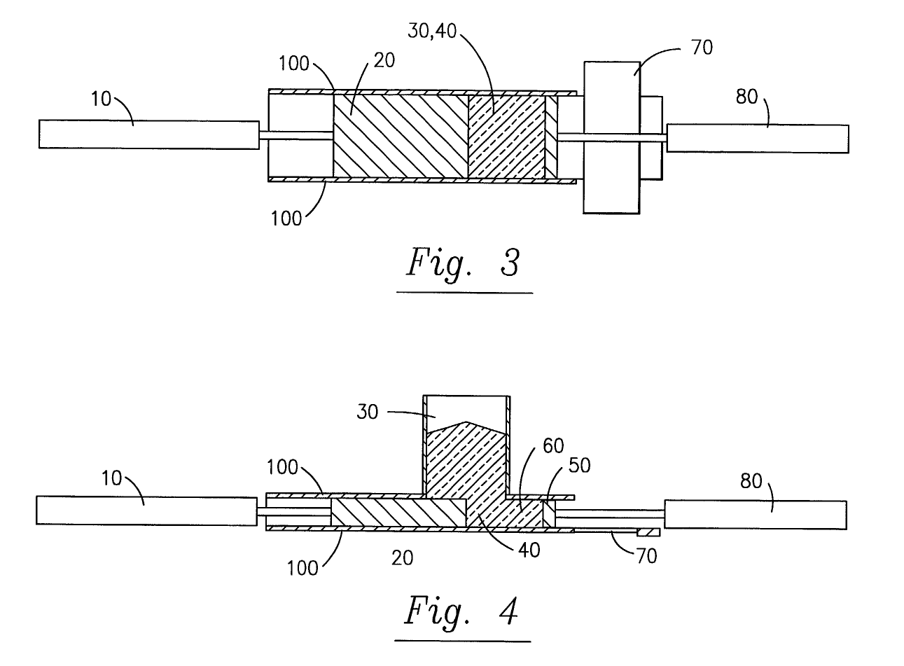

Referring now to FIG. 3 and FIG. 4, the rear ram 20 has a solid, flat top surface. The front ram 50 and rear ram 20 advance in concert, thus taking the 120 cubic inch crumb charge into the mold chamber 60 as the solid flat top surface of the rear ram 20 seals off the crumb in the feed chute 30.

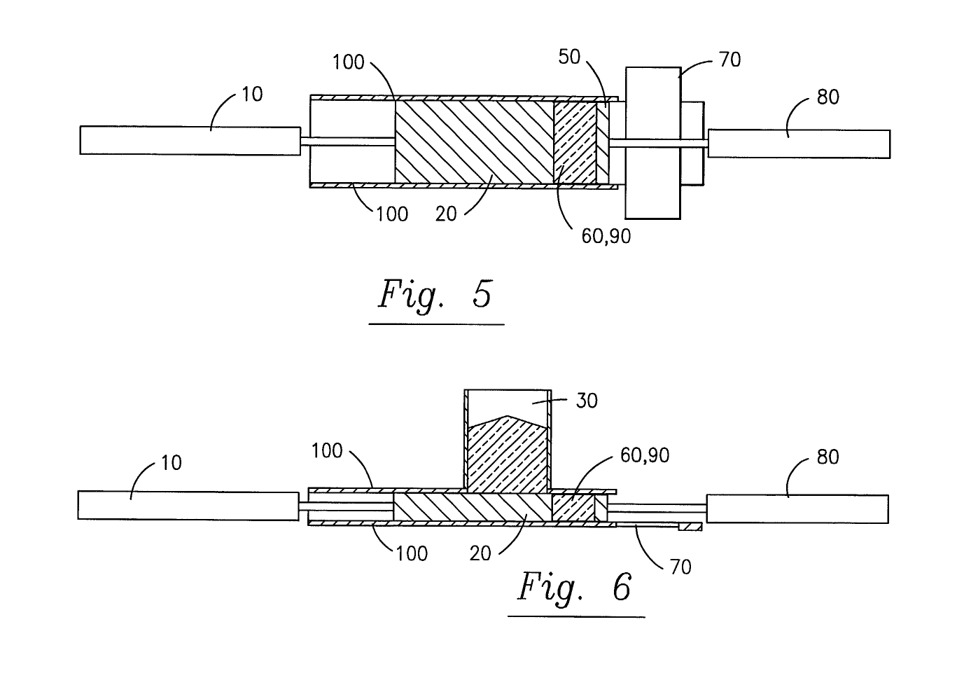

Turning now to FIG. 5 and FIG. 6, the front ram 50 stops its motion at the right side of the mold chamber 60 and reverses while the rear ram 20 continues its advance into the mold chamber 60 until the face of rear ram 20 and the face of front ram 50 are preferably 3⅝ inches apart. The mold chamber 60 dimensions are preferably 7½ inches long by 2¼ inches high by 7⅝ inches wide. In a preferred embodiment of the present invention, the crumb is thus compressed into a 62.2 cubic inch brick measuring 7⅝ inches by 3⅝ inches by 2¼ inches.

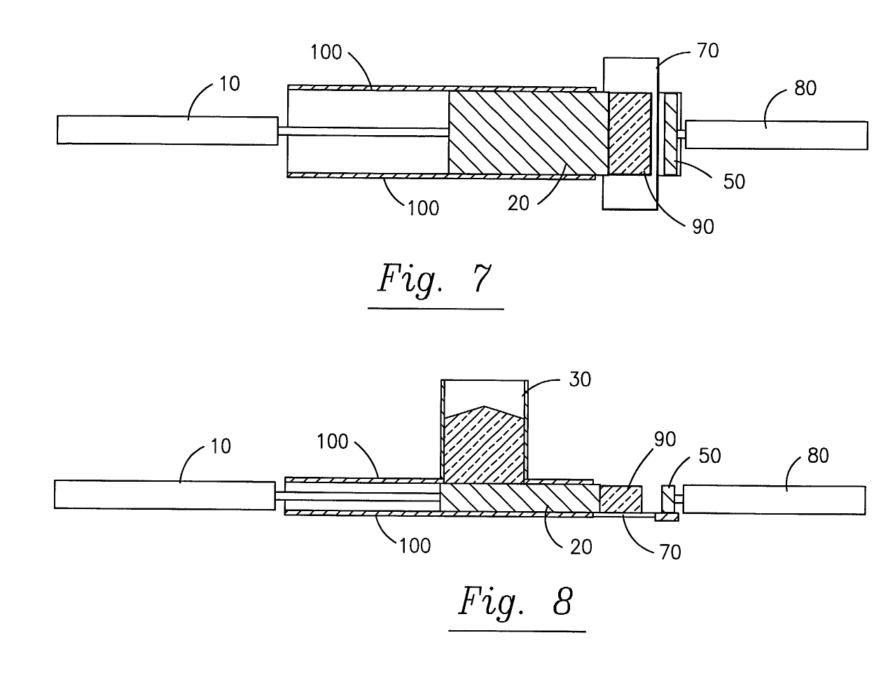

Referring to FIG. 7 and FIG. 8, the front ram 50 then retracts from the mold chamber 60, across the indexing plate 70 to its home position. The rear ram 20 then pushes the brick 90 onto the indexing plate 70 and immediately retracts into the mold chamber 60 and pauses while the indexing plate 70 indexes and is ready to receive another brick 90.

Referring once again to FIG. 1 and FIG. 2, the front ram 50 now extends across the indexing plate 70, enters the mold chamber 60, and follows the retraction of rear ram 20 until it reaches its position at the right side of the mold chamber 60. The rear ram 20 continues retracting to its starting position. In a preferred embodiment of the present invention, the face of the rear ram 20 is 7 inches away from the face of front ram 50. The crumb falls into the charge chamber 40 as the rear ram 20 retracts and the cycle begins again.

The molding machine of the present invention may be powered any number of ways. In a preferred embodiment of the present invention, however, hydraulically powered computer-controlled servo valves enable cycle times of approximately 10 seconds. The adjustable cycle time of the mold units determines the speeds of every device in this continuous process. When utilized as hereinabove described, the machine of the present invention facilitates a turnaround time of just over eight hours between mixing, molding, racking, and final palletizing, inasmuch as the machine of the present invention can utilize a mix moist enough to permit ambient self-curing of about eight hours, and no apparatus, energy, or time for steam-curing or similar assisted curing after molding is required.

This abbreviated turn-around time is also facilitated by the continuous flow of crumb to the charge chamber 40. As is seen in FIG. 2, the charging chamber itself serves as a measuring and shaping device prior to the compression function when the front 50 and rear 20 rams are in the charging position. No batch-to-mix weighings are performed in the production sequence. Color may be added on a continuous basis, even changing colors, without stopping and cleaning the machine. A few transitional bricks will be produced, but the machine is self-cleaning and may proceed apace.

The ramifications of this production turn-around time of approximately eight hours are that unsold brick inventory can be completely eliminated, as it will be appreciated that the general construction industry's order-to-consumption time is a minimum of two months. Moreover, the ability to change color “on the fly” during the continuous production process enhances the ability to respond immediately to changes in demand.

The actual molding step in the mold chamber 60 seen in FIG. 6 compresses the brick 90 along the horizontal axis in both the plus “x” and minus “x” directions simultaneously. Thus, instead of vibrating and pressuring one axis, as is common in the prior art, the mold unit of the present invention simply provides uniform compression across the faces of the brick 90. This makes the density of brick 90 homogeneous throughout its cross-section. Further, the brick 90 possesses greatly enhanced compressive strength, as noted above in test Examples 1 through 4.

To create a paver, as opposed to face brick, the machine of the present invention operates in the same ways described above, except the face of the rear ram 20 and front ram 50 preferably are changed to 4 inches by 8 inches and the compression mold chamber 60 profile preferably is 4 inches high by 8 inches wide. The rams 20 and 50 transport and compress the mix as previously described and produce a 4 inch by 8 inch by 2 inch paver by pressurizing the +x and −x horizontal axis.

The machine of the present invention may be arranged in multiples, four in a row, for example, so that one cycle produces four bricks 90. The bricks 90 are ejected onto an indexing plate 70 that, as filled, proceeds to a standard indexing rack (not shown) which when filled contains 480 bricks 90. The rack may be trolley mounted and may join a row of racks previously filled. The bricks 90 then await 8 hours minimum self-curing in ambient conditions. The full rack may then be transferred to another trolley track to proceed to palletizing. It will be appreciated that the brick 90 may be tumbled prior to palletizing to produce irregular edges and corners.

As shown in FIG. 1, the indexing plate 70 of the present invention is preferably 5 inches wide, 120 inches long, ⅜ inch thick and capable of holding 12 bricks or pavers when full. The indexing plate 70 is positioned perpendicularly, between the spaces of rear ram 20 and front ram 50, to multiple parallel mold units of the present invention, which may preferably be spaced 30 inches apart on center so that the indexing plate 70 receives one brick from each mold unit on each cycle. The indexing plate 70 then indexes and receives the next cycle of bricks 90. A ten inch index between cycles results in two inch spacing between the ends of brick 90 pavers and a 2⅜ inch spacing between brick 90 ends. Three cycles fill one indexing plate 70. The plate 70 is then set into a receiving rack and a new empty plate 70 is positioned to receive the next cycle of bricks 90.

The above description and the accompanying drawings show that the present invention provides a novel molding apparatus which not only overcomes the deficiencies and shortcomings of the prior art, but also provides novel features and advantages not found in previous apparatus. The apparatus of the invention produces bricks continuously in a self-cleaning fashion and without any steam-curing machinery or vibrating parts. Unlimited production runs are enabled by concurrently weighed and fed components. Colors can be changed on the fly, without stopping production and cleaning the apparatus.

The continuous molding apparatus of the invention is simpler in design than the prior art and less expensive in light of the reduced mechanical assembly costs and maintenance costs. The apparatus is durable in construction and has a long useful life. Commercially available materials and components can be utilized in the fabrication of the molding apparatus using conventional metal working techniques and procedures.

The apparatus of the invention can be utilized to mold a variety of different products. Variations in composition, structure, and surface appearance of the product can be achieved simply and quickly with the apparatus of the invention.

It will be apparent that various modifications can be made in the particular continuous molding apparatus as described in detail above and shown in the drawings within the scope of the present invention. The size, configuration, and arrangement of components and materials can be changed to meet specific requirements. For example, the continuous molding apparatus can be modified to produce square, rather than rectangular, bricks or pavers by merely altering the receiver plate index length. Altering the angular placement of the supporting frame relative to the front and/or rear ram faces would permit production of triangular or other shaped bricks or pavers. These and other changes can be made in the continuous molding apparatus provided the functioning and operation thereof are not adversely affected. Therefore, the scope of the present invention is to be limited only by the following claims.

What is claimed is:

1. A continuous molding apparatus comprising a raw material accepting portion, a raw materials supplying portion, a mixing portion, a mixture delivery portion, a molding portion, a supporting portion, and an indexing portion; said raw material supplying portion comprising a feed chute; said mixing portion comprising an elongated chamber and means for mixing; and said molding portion comprising a chamber formed by a supporting portion and faces of two opposed ram assemblies having a face at one end and a cylinder assembly generating advancing and retracting movement at the other end.

2. A continuous molding apparatus comprising:
(a) a rear cylinder;
(b) a rear ram;
(c) a feed chute;
(d) a charge chamber;
(e) a front ram;
(f) a mold chamber;
(g) an indexing plate;
(h) a front cylinder; and
(i) a supporting frame.

3. The continuous molding device of claim 2, wherein the feed chute is continuously charged.

4. The continuous molding apparatus of claim 2, wherein the charging chamber functions as a measuring and shaping device prior to the compressing function when the front and rear rams are in the charging position.

5. The continuous molding apparatus of claim 2, wherein the solid top of the rear ram functions as a shutoff valve at the bottom of the feed chute as it progresses from the charge chamber into the mold chamber.

6. The continuous molding apparatus of claim 2, wherein the rear ram and front ram and supporting frame compress the charging material in one axis, in both the positive and negative directions of the axis.

7. The continuous molding apparatus according to claim 2, wherein the rear ram delivers the charging material, once compressed into brick, to an indexing receiver plate.

8. The continuous molding apparatus according to claim 2, wherein the indexing receiver plate travels perpendicularly across the open gap between the front and rear ram.

9. The continuous molding apparatus according to claim 2, wherein the indexing brick or paver receiver plate is positioned perpendicularly, between the front and rear ram faces, to multiple parallel molding units.

10. The continuous molding apparatus according to claim 2, wherein the indexing brick or paver receiver plate is positioned perpendicularly, between the front and rear ram faces, to multiple parallel molding units spaced 30 inches apart on center.

11. The continuous molding apparatus according to claim 9, wherein the indexing brick or paver receiver plate is 5 inches wide, 120 inches long, ⅜ inches thick and may hold 12 bricks or pavers when full.

12. The continuous molding apparatus according to claim 2, wherein the rear ram and front ram and supporting frame form the configuration of a triangle, square, or other design when fully compressing the charging material.

13. A machine for making brick and brick paver, comprising a frame having an indexing plate; a pair of reciprocal ram heads, each driven by a separate dual-action hydraulic cylinder having an internal piston; and a charge chamber having a flat bottom and fed by a feed chute; said pair of ram heads comprising a front ram and a rear ram that move in concert along the flat bottom of said charge chamber, thereby causing the measurement of the correct amount of charge and its positioning into a mold chamber formed by the selective alignment of said ram heads, said flat bottom of said feed chute, and said frame; said rear ram having a solid flat upper surface for sealing off additional charge in said feed chute; said front and rear rams being selectively moveable and stoppable at the right side of said mold chamber, and reversible to appropriate distances and across said indexing plate to home positions, for compressing said charge into an appropriately sized brick or paver, pushing said brick onto said indexing plate, immediately retracting into said mold chamber, and pausing to allow indexing plate to index and receive another brick, and further retracting to its starting position.
